(19) United States
(12) Patent Application Publication
(10) Pub. No.: US 2010/0226245 A1
(43) Pub. Date: Sep. 9, 2010

(54) METHOD AND APPARATUS FOR PROTECTION SWITCHING IN RING NETWORK

(76) Inventors: Jeong-Dong RYOO, Daejeon (KR); Sang-Min LEE, Daejon (KR); Daeub KIM, Daejon (KR); Bhum-Cheol LEE, Daejon (KR)

Correspondence Address: LADAS & PARRY LLP, 224 SOUTH MICHIGAN AVENUE, SUITE 1600, CHICAGO, IL, 60604, US

(21) Appl. No.: 12/706,093

(22) Filed: Feb. 16, 2010

(30) Foreign Application Priority Data
Feb. 16, 2009 (KR) 10-2009-0012610

(51) Int. Cl. G06F 11/00

(52) U.S. Cl. 370/225

(57) ABSTRACT

A method and apparatus for protection switching in a ring network are provided. A method for protection switching in a ring network, which includes a first ring network having first and second connection nodes and a second ring network connected with the first ring network through the first and second connection nodes, includes: receiving, by the first connection node, first and second R-APS messages transmitted from nodes belonging to the first ring network; determining, by the first connection node, the position of closure in the first ring network by using the first and second R-APS messages and topology information; receiving, by the first connection node, a topology change signal transmitted from the second ring network; and transmitting, by the first connection node, an FDB flush message with reference to the position of closure.

### CROSS-REFERENCE(S) TO RELATED APPLICATIONS

The present application claims priority of Korean Patent Application No. 10-2009-0012610, filed on Feb. 16, 2009, which is incorporated herein by reference in its entirety.

### BACKGROUND OF THE INVENTION

1. Field of the Invention

Exemplary embodiments of the present invention relate to a method and apparatus for protection switching in a ring network.

2. Description of Related Art

A ring network refers to a network in which both ports belonging to each node are connected to ports of adjacent nodes, respectively, in a ring shape. In such a ring network, a specific one of ports belonging to the ring is closed to prevent loop formation when traffic is transmitted. If the ring network fails, ports that have been closed are opened, and ports of the failed nodes are closed, eventually changing the topology of the ring network. In order to correctly transmit packets according to the changed network topology, each node belonging to the corresponding ring network flushes its Filtering DataBase (FDB).

A plurality of ring networks can be connected to one another to form an extended ring network. Specifically, a major ring has at least one sub-ring connected thereto, and the sub-ring (upper sub-ring) has other sub-rings (lower sub-rings) connected thereto. In this manner, the ring network is extended. The connection between the major ring and the sub-ring or between the upper and lower sub-rings is made through two different connection nodes.

In case where a sub-ring (or lower sub-ring) fails in the ring network extended by the connection of different rings, the FDB of all nodes of the failed sub-ring (or lower sub-ring) is flushed. At the same time, the FDB of all nodes of the major ring (or upper sub-ring) is flushed. Such flushing of the FDB of all nodes of the major ring (or upper sub-ring) causes a traffic overshoot phenomenon. As a result, rapid protection switching in the case of a failure requires a larger network bandwidth.

### SUMMARY OF THE INVENTION

An embodiment of the present invention is directed to a method and apparatus for protection switching in a ring network, which are capable of reducing the network bandwidth necessary for rapid protection switching in the case of a failure.

Another embodiment of the present invention is directed to a method and apparatus for performing protection switching in a ring network, which are capable of reducing the time necessary for protection switching and efficiently performing the protection switching by flushing the FDB of a limited range of nodes of an upper ring, not its all nodes, when a failure occurs in a lower ring of the ring network.

In accordance with an embodiment of the present invention, a method for protection switching in a ring network comprising a first ring network having first and second connection nodes and a second ring network connected to the first ring network through the first and second connection nodes, includes: receiving, by the first connection node, first and second Ring-Auto Protection Switching (R-APS) messages transmitted from nodes belonging to the first ring network; determining, by the first connection node, the position of closure in the first ring network by using the first and second R-APS messages and topology information; receiving, by the first connection node, a topology change signal transmitted from the second ring network; and transmitting, by the first connection node, a Filtering DataBase (FDB) flush message with reference to the position of closure.

In accordance with another embodiment of the present invention, an apparatus for protection switching in a ring network comprising a first ring network having first and second connection nodes and a second ring network connected with the first ring network through the first and second connection nodes, includes: a receiver configured to receive first and second R-APS messages transmitted from nodes belonging to the first ring network and a topology change signal transmitted from the second ring network; a controller configured to determine the position of closure in the first ring network by using the first and second R-APS messages and topology information; and a transmitter configured to transmit a FDB flush message with reference to the position of closure.

In accordance with another embodiment of the present invention, a method for protection switching in a ring network includes: receiving a FDB flush message by an arbitrary node; performing a FDB flush operation by the arbitrary node; and determining whether to transmit or discard the FDB flush message by the arbitrary node.

In accordance with another embodiment of the present invention, an apparatus for protection switching in a ring network includes: a receiver configured to receive a FDB flush message; and a controller configured to perform a FDB flush operation and determine whether to transmit or discard the FDB flush message.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a configuration diagram of an apparatus for protection switching in a ring network in accordance with a specific embodiment of the present invention.

FIG. 2 is a configuration diagram of a ring network, to which a method for protection switching in a ring network in accordance with a specific embodiment of the present invention is applicable.

FIG. 3 shows an example of topology information used to determine the position of closure.

FIG. 4 is a table explaining a method for determining the position of closure by a connection node in accordance with an embodiment of the present invention.

FIG. 5 is a network configuration diagram illustrating a protection switching method in accordance with an embodiment of the present invention.

FIG. 6 is a flowchart illustrating a method for protection switching in a ring network in accordance with an embodiment of the present invention.

FIG. 7 is a flowchart illustrating a method for protection switching in a ring network in accordance with another embodiment of the present invention.

FIG. 8 is a flowchart illustrating a method for protection switching in a ring network in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

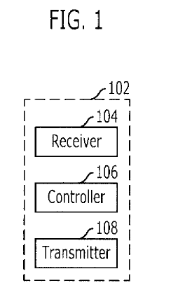

FIG. 1 is a configuration diagram of an apparatus for protection switching in a ring network in accordance with a specific embodiment of the present invention.

When assuming an interconnection between a major ring and a sub-ring or between an upper sub-ring and a lower sub-ring, the major ring or the upper sub-ring will be referred to as an upper ring network or simply an upper ring, and the sub-ring or the lower sub-ring will be referred to as a lower ring network or simply a lower ring.

Referring to FIG. 1, a protection switching apparatus 102 in accordance with a specific embodiment of the present invention includes a receiver 104, a controller 106, and a transmitter 108.

The function of each component of the protection switching apparatus 102 in accordance with an embodiment of the present invention will now be described. The receiver 104 is configured to receive a Ring-Auto Protection Switching (R-APS) message transmitted from an arbitrary node belonging to the upper ring network. The R-APS message may include ID information regarding the arbitrary node that has sent the message, and is used to determine the position of closure in the upper ring network together with topology information. The receiver 104 is also configured to receive a topology change signal transmitted from the lower ring network. As used herein, the topology change signal refers to a signal which is transmitted from the lower ring network to the upper ring network when the topology of the lower ring network has changed, and includes a failure occurrence signal, a failure restoration signal, a forced switching signal, a manual switching signal, a FDB flush signal, etc.

The controller 106 is configured to determine the position of closure in the upper ring network by using R-APS messages received by the receiver 104, as well as topology information. In accordance with an embodiment of the present invention, the controller 106 determines the position of nodes, which have transmitted two different R-APS messages, by using the topology information. Based on the determined position of the two nodes that have transmitted the R-APS messages, the controller 106 determines whether the position of closure in the upper ring network is to the left of a connection node, to its right, or neutral. As used herein, the topology information refers to information regarding connection nodes belonging to the upper ring network, and includes sub-ring information, self-node information, peer node information, left node information, right node information, etc.

The transmitter 108 is configured to transmit a FDB flush message with reference to the position of closure in the upper ring determined by the controller 106. In accordance with an embodiment of the present invention, when it is determined that the position of closure in the upper ring is to the left or right of a connection node, which is supposed to transmit a FDB flush message, the transmitter 108 transmits a FDB flush message in a direction opposite to the position of closure. When the position of closure in the upper ring is determined to be neutral, the transmitter 108 may not transmit a FDB flush message.

The function of each component of a protection switching apparatus 102 in accordance with another embodiment of the present invention will now be described. The receiver 104 is configured to receive a FDB flush message transmitted by a different node.

The controller 106 is configured to perform a FDB flush operation according to the FDB flush message received by the receiver 104. The controller 106 is also configured to determine whether to transmit the received FDB flush message to the next node or to discard it. If the FDB flush message has been received by a normal node, not a connection node, the controller 106 transmits the FDB flush message to the next node by using the transmitter 108. If the FDB flush message has been received by a connection node, the controller 106 confirms whether the FDB flush message has been transmitted by a peer node corresponding to the connection node or not. If it is confirmed that the FDB flush message has been transmitted by a peer node corresponding to the connection node, the controller 106 discards the FDB flush message and if not, the controller 106 transmits the FDB flush message to the next node.

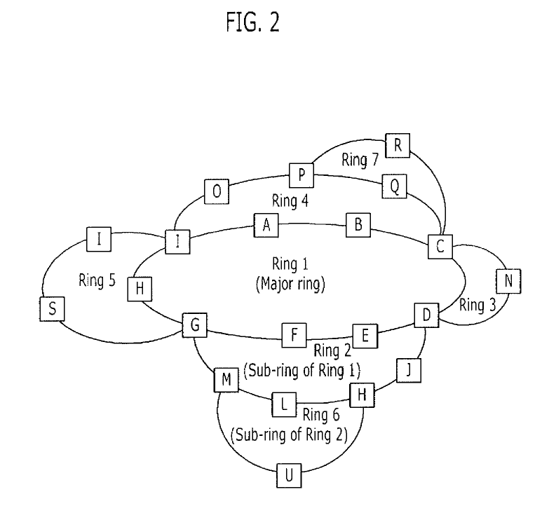

FIG. 2 is a configuration diagram of a ring network, to which a method for protection switching in a ring network in accordance with a specific embodiment of the present invention is applicable.

Referring to FIG. 2, a plurality of ring networks can be connected to one another to constitute a single ring network. Ring 1 is a major ring, to which a number of sub-rings (Ring 2, Ring 3, Ring 4, and Ring 5) are connected. Ring 1 includes nine nodes A to I, and nodes to which a sub-ring is connected are defined as connection nodes of the major ring. For example, in terms of the relationship between Rings 1 and 2, Ring 2 is connected to Ring 1 through nodes D and G of Ring 1. Therefore, Nodes D and G are connection nodes of the major ring (Ring 1). The remaining nodes A, B, C, E, F, H, and I, which are not connection nodes, are defined as normal nodes.

A sub-ring can have another sub-ring connected thereto. For example, Ring 6 is connected to Ring 2, and in this connection, Ring 2 is referred to as an upper sub-ring, and Ring 6 is a lower sub-ring. Ring 6 is connected to Ring 2 through nodes K and M, which are then defined as connection nodes of Ring 2.

As such, each connection between ring networks can be understood as that between upper and lower rings. For example, in terms of the relationship between Rings 1 and 2, Ring 1 is the upper ring, and Ring 2 is the lower ring; in terms of the relationship between Rings 2 and 6, Ring 2 is the upper ring, and Ring 6 is the lower ring.

A method for protection switching in a ring network in accordance with an embodiment of the present invention will now be described with reference to FIG. 2, which illustrates the construction of a network, based on the following assumptions: Any ring network has an R-APS channel and a client channel, which are separate from each other, and each ring network has a different R-APS channel. A protocol message regarding protection switching (e.g. R-APS message) can be transmitted through the R-APS channel. If a node has an occurring condition, such as normal operation, failure, forced switching, manual switching, etc., the node generates an R-APS message corresponding to each condition. Every R-APS message contains ID information regarding the node that has transmitted the message.

A method for protection switching in accordance with an embodiment of the present invention will now be described with reference to Rings 1 and 2 illustrated in FIG. 2 for clarity.

Referring to the network configuration of FIG. 2, if the topology of Ring 2 is changed by a failure, the node that has caused the failure in Ring 2 creates and transmits a topology change signal to notify of the failure. A connection node D or G of Ring 1 receives the topology change signal from Ring 2. As mentioned above, the conventional approach in such a circumstance would be as follows: a connection node of Ring 1 receives the topology change signal and transmits a FDB flush message; then all nodes of Ring 1 flush their FDB. Such an approach causes a traffic overshoot and requires a larger network bandwidth for protection switching. In order to overcome such problems occurring in the prior art, the present invention provides a protection switching method in which, when the topology changes, FDB flush operations are performed with regard to a minimum number of nodes necessary.

The process of receiving a topology change signal, which has been transmitted from the lower ring, by a connection node of the upper ring and then transmitting a corresponding FDB flush message will now be described. Referring to FIG. 2, a connection node D or G of Ring 1 receives a topology change signal from Ring 2 and transmits a FDB flush message with reference to the position of closure in Ring 1. In order to determine the position of closure in Ring 1, the connection node utilizes a R-APS message transmitted from a different node (connection node or normal node), as well as topology information.

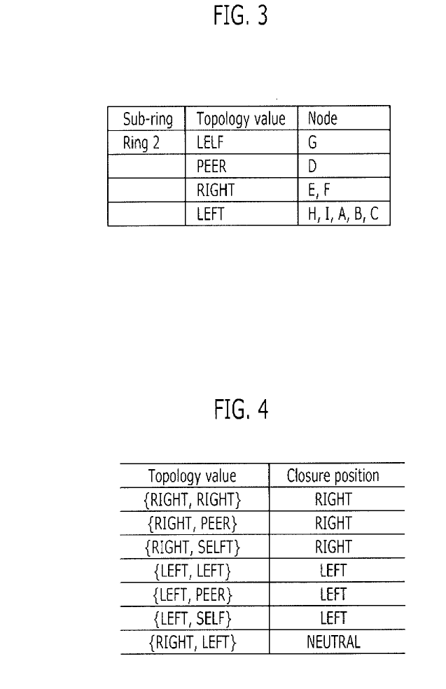

FIG. 3 illustrates an example of topology information used to determine the position of closure.

In accordance with an embodiment of the present invention, connection nodes of each ring have topology information as shown in FIG. 3. The topology information includes sub-ring information, self-node information, peer node information, left node information, right node information, etc.

FIG. 3 shows topology information held by the connection node G illustrated in FIG. 2. Ring 2 is connected to Ring 1 through the connection node G as a lower ring, so “Ring 2” is stored as sub-ring information as shown in FIG. 3. The ID of the node, i.e. G, is stored as self-node information SELF. The ID of the connection node corresponding to the self-node (i.e. node G) is D, which is stored as peer node information PEER. The IDs of nodes positioned to the right of node G between nodes G and D are E and F, which are stored as right node information RIGHT. The IDs of nodes positioned to the left of node G between nodes G and D are H, I, A, B, and C, which are stored as left node information LEFT.

FIG. 4 is a table explaining a method for determining the position of closure by a connection node in accordance with an embodiment of the present invention.

When assuming that the connection node G has topology information shown in FIG. 3, it determines the position of closure in the upper ring (i.e. Ring 1) by using two different R-APS messages received from those of its ports, which are connected to the upper ring, as well as the topology information. For example, the connection node G receives first and second R-APS messages from its left port, which faces node H, or the right port which faces node F. As mentioned above, the first and second R-APS messages include the ID of nodes that have transmitted the messages, respectively. Therefore, the connection node G can determine the position of nodes that have transmitted the first and second R-APS messages, respectively, with reference to the topology information.

Referring to FIG. 4, the “Topology value” column enumerate order pairs, each of which corresponds to the position of nodes that have transmitted the first and second R-APS messages determined in the above-mentioned process, and the “Closure position” column enumerates the position of closure in Ring 1, which corresponds to each ordered pair. For example, if the first and second R-APS messages have been transmitted by nodes E and D, respectively, the position of the nodes corresponds to {RIGHT, PEER} based on the topology information shown in FIG. 3. The corresponding closure position in FIG. 4 is “RIGHT.” Therefore, the connection node G determines that the position of closure in Ring 1 is to the right of node G. Similarly, if the node IDs contained in the first and second R-APS messages are A and C, respectively, it will be determined that the closure position is “LEFT”. If the node IDs of the first and second R-APS messages are F and B, respectively (or vice versa), it is determined that the closure position is “NEUTRAL”.

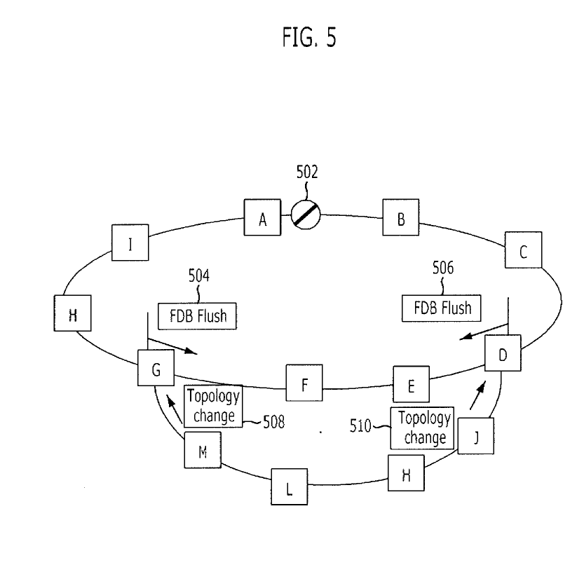

FIG. 5 is a network configuration diagram illustrating a protection switching method in accordance with an embodiment of the present invention.

For clarity, Rings 1 and 2 of the network, the construction of which is illustrated in FIG. 2, are solely shown in FIG. 5. As has been described with reference to FIGS. 3 and 4, the connection nodes D and G of Ring 1 have confirmed the position of closure 502 in Ring 1 by using the R-APS messages and topology information. Specifically, nodes D and G have recognized that the position of closure 502 is to their right and left, respectively.

If a topology change occurs in Ring 2 in such a situation, a topology change signal (failure occurrence signal, failure restoration signal, forced switching signal, manual switching signal, FDB flush message, etc.) is transmitted to Ring 1. After receiving a topology change signal 508 or 510 from Ring 2, the connection node D or G transmits a corresponding FDB flush message 504 or 506. In this case, the connection node transmits the FDB flush message 504 or 506 in a direction opposite to the position of closure 502 confirmed in the preceding process. Specifically, the connection node G transmits the FDB flush message 504 away from the position of closure 502 (which is to the left of the node), i.e., to the left, and the connection node D transmits the FDB flush message 506 away from the position of closure 502 (which is to the right of the node), i.e., to the left. If the position of closure 502 is confirmed neutral, the connection node transmits no FDB flush message.

Through the above-mentioned process, the connection node receives a topology change signal from Ring 2 and transmits a FDB flush message in a direction opposite to the position of closure.

A process of receiving and processing the FDB flush message, which has been transmitted by the connection node, by a node (connection node or normal node) will now be described.

Referring to FIG. 5, if the connection node transmits a FDB flush message 504, nodes positioned to the right of the connection node G receive the FDB flush message 504. A node that has received the FDB flush message performs an FDB flush operation. In accordance with another embodiment of the present invention, the FDB flush operation may be performed only when a normal node, not a connection node, has received the FDB flush message.

A node that has received the FDB flush message determines whether to transmit the FDB flush message to the next node or to discard the message. If a normal node has received the FDB flush message, it does not discard the FDB flush message, but transmits the message to the next node.

For example, referring to FIG. 5, when the normal node F receives the FDB flush message 504 transmitted by the connection node G, the normal node F transmits the received FDB flush message 504 to the next node E before or after performing an FDB flush operation.

When a connection node receives the FDB flush message, the connection node determines whether the FDB flush message has been transmitted by a peer node corresponding to the connection node or not by using the node ID contained in the FDB flush message. If it is confirmed that the FDB flush message has been transmitted by a peer node corresponding to the connection node, it discards the received FDB flush message. If the FDB flush message has not been transmitted by a peer node corresponding to the connection node, it does not discard the FDB flush message, but transmits the message to the next node.

It will be assumed for example that the normal node F in FIG. 5 has transmitted the FDB flush message 504 to node E. Although node E is classified as a normal node in terms of the relationship between Rings 1 and 2, it may be a connection node in terms of a relationship between Ring 1 and a different ring. In other words, if another sub-ring is connected to Ring 1 via its nodes B and E as connection nodes, node E is classified as a connection node, not a normal node. Therefore, after receiving the FDB flush message 504, the connection node E confirms by using the node ID contained in the FDB flush message 504 that the FDB flush message 504 has been transmitted by the connection node G.

The connection node E then checks its topology information, which contains self-node information E and peer node information B. The connection node E confirms with reference to the topology information that the connection node G, which has transmitted the FDB flush message 504, is not its peer node (i.e. node B). Therefore, the connection node E does not discard the received FDB flush message, but transmits it to the next node D.

After receiving the FDB flush message 504 from node E, the connection node D confirms that the FDB flush message 504 has been transmitted by node G, and that node G is its peer node with reference to the topology information. Therefore, the connection node D discards the FDB flush message 504, which is no longer transmitted to other nodes.

Referring to FIG. 5, the FDB flush message 506 created by the connection node D is transmitted no further than the connection node G in a similar manner. As a result, when a topology change occurs in Ring 2, FDB flush operations are not performed with regard to all nodes of Ring 1, but only with regard to those related to the topology change in Ring 2, i.e. nodes D, E, F, and G.

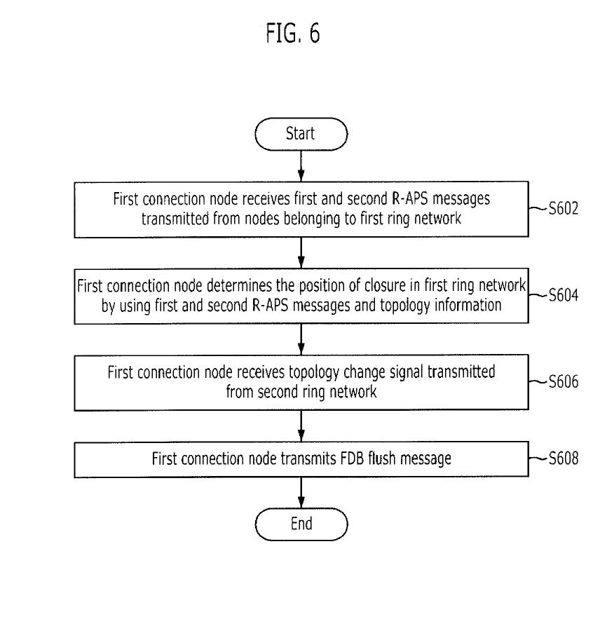

FIG. 6 is a flowchart illustrating a method for protection switching in a ring network in accordance with an embodiment of the present invention.

When assuming that a first ring network including first and second connection nodes is connected to a second ring network through the first and second connection nodes, the first connection node receives first and second R-APS messages transmitted by nodes belonging to the first ring network at step S602. The first connection node determines the position of closure in the first ring network by using the received first and second R-APS messages and topology information at step S604.

After determining the position of closure in the first ring network, the first connection node receives a topology change signal transmitted from the second ring network at step S606. After receiving the topology change signal, the first connection node transmits a FDB flush message with reference to the position of closure in the first ring network at step S608.

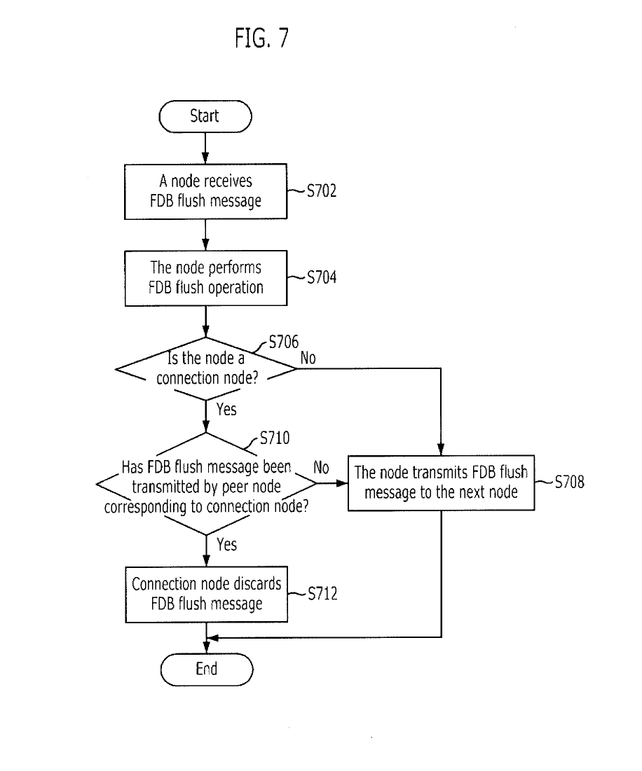

FIG. 7 is a flowchart illustrating a method for protection switching in a ring network in accordance with another embodiment of the present invention.

A node belonging to the ring network receives a FDB flush message at step S702. After receiving the FDB flush message, the node performs an FDB flush operation at step S704.

If it is confirmed that the node is not a connection node at step S706, the node transmits the FDB flush message to the next node at step S708. If it is confirmed that the node is a connection node at the step S706, the connection node confirms whether the FDB flush message has been transmitted by a peer node corresponding to the connection node or not at step S710. If it is confirmed that the FDB flush message has not been transmitted by a peer node corresponding to the connection node, the node (i.e. connection node) transmits the FDB flush message to the next node at step S708. If it is confirmed that the FDB flush message has been transmitted by a peer node corresponding to the connection node, the connection node discards the FDB flush message at step S712.

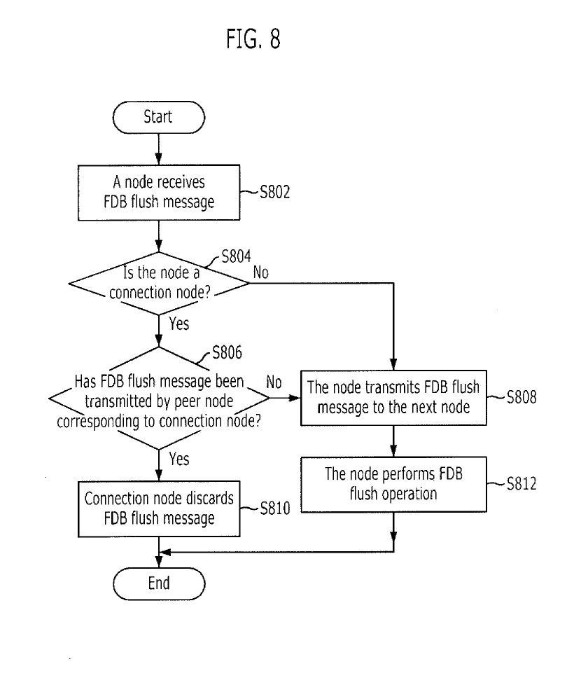

FIG. 8 is a flowchart illustrating a method for protection switching in a ring network in accordance with still another embodiment of the present invention.

The flow of operations in accordance with another embodiment of the present invention shown in FIG. 8 is similar to that in accordance with the embodiment shown in FIG. 7, except for the point of time at which a node performs an FDB flush operation.

A node receives a FDB flush message at step S802. If it is confirmed that the node is not a connection node at step S804, the node transmits the FDB flush message to the next node at step S808. The node then performs an FDB flush operation at step S812.

If it is confirmed that the node is a connection node at the step S804, the node confirms whether the FDB flush message has been transmitted by a peer node corresponding to the connection node or not node at step S806 and, if not, transmits the FDB flush message to the next node at step S808. The node then performs an FDB flush operation at step S812. If it is confirmed at the step S806 that the FDB flush message has been transmitted by a peer node corresponding to the connection node, the node (i.e. connection node) discards the FDB flush message at step S810.

In accordance with the embodiment shown in FIG. 8, the FDB flush operation based on the FDB flush message is performed only by a normal node or a connection node which does not correspond to the connection node that has transmitted the FDB flush message.

While the present invention has been described with respect to the specific embodiments, it will be apparent to those skilled in the art that various changes and modifications may be made without departing from the spirit and scope of the invention as defined in the following claims.

What is claimed is:

1. A method for protection switching in a ring network comprising a first ring network having first and second connection nodes and a second ring network connected to the first ring network through the first and second connection nodes, the method comprising:
receiving, by the first connection node, first and second Ring-Auto Protection Switching (R-APS) messages transmitted from nodes belonging to the first ring network;
determining, by the first connection node, the position of closure in the first ring network by using the first and second R-APS messages and topology information;
receiving, by the first connection node, a topology change signal transmitted from the second ring network; and
transmitting, by the first connection node, a Filtering DataBase (FDB) flush message with reference to the position of closure.

2. The method of claim 1, wherein the first or second R-APS message comprises ID information regarding the node that has transmitted the R-APS message.

3. The method of claim 1, wherein the topology information comprises self-node information, peer node information, left node information, and right node information.

4. The method of claim 1, wherein said determining, by the first connection node, the position of closure in the first ring network by using the first and second R-APS messages and topology information comprises:
determining the position of the node that has transmitted the first R-APS message and the position of the node that has transmitted the second R-APS message by using the topology information;
determining that the position of closure is to the left of the first connection node when the position of the node that has transmitted the first R-APS message is to the left of the first connection node and the position of the node that has transmitted the second R-APS message corresponds to the first or second connection node or is to the left of the first connection node;
determining that the position of closure is to the right of the first connection node when the position of the node that has transmitted the first R-APS message is to the right of the first connection node and the position of the node that has transmitted the second R-APS message corresponds to the first or second connection node or is to the right of the first connection node; and
determining that the position of closure is neutral when the position of the node that has transmitted the first R-APS message is to the right of the first connection node and the position of the node that has transmitted the second R-APS message is to the left of the first connection node or when the position of the node that has transmitted the first R-APS message is to the left of the first connection node and the position of the node that has transmitted the second R-APS message is to the right of the first connection node.

5. The method of claim 1, wherein said transmitting, by the first connection node, a FDB flush message with reference to the position of closure comprises transmitting the FDB flush message in a direction opposite to the position of closure when the position of closure is to the left or right of the first connection node.

6. The method of claim 1, wherein the topology change signal comprises one of a failure occurrence signal, a failure restoration signal, a forced switching signal, a manual switching signal, and a FDB flush message.

7. An apparatus for protection switching in a ring network comprising a first ring network having first and second connection nodes and a second ring network connected with the first ring network through the first and second connection nodes, the apparatus comprising:
a receiver configured to receive first and second R-APS messages transmitted from nodes belonging to the first ring network and a topology change signal transmitted from the second ring network;
a controller configured to determine the position of closure in the first ring network by using the first and second R-APS messages and topology information; and
a transmitter configured to transmit a FDB flush message with reference to the position of closure.

8. The apparatus of claim 7, wherein the first or second R-APS message comprises ID information regarding the node that has transmitted the R-APS message.

9. The apparatus of claim 7, wherein the topology information comprises self-node information, peer node information, left node information, and right node information.

10. The apparatus of claim 7, wherein the controller is configured to determine the position of the node that has transmitted the first R-APS message and the position of the node that has transmitted the second R-APS message by using the topology information,
determine that the position of closure is to the left of the first connection node when the position of the node that has transmitted the first R-APS message is to the left of the first connection node and the position of the node that has transmitted the second R-APS message corresponds to the first or second connection node or is to the left of the first connection node,
determine that the position of closure is to the right of the first connection node when the position of the node that has transmitted the first R-APS message is to the right of the first connection node and the position of the node that has transmitted the second R-APS message corresponds to the first or second connection node or is to the right of the first connection node, and
determine that the position of closure is neutral when the position of the node that has transmitted the first R-APS message is to the right of the first connection node and the position of the node that has transmitted the second R-APS message is to the left of the first connection node or when the position of the node that has transmitted the first R-APS message is to the left of the first connection node and the position of the node that has transmitted the second R-APS message is to the right of the first connection node.

11. The apparatus of claim 7, wherein the transmitter is configured to transmit the FDB flush message in a direction opposite to the position of closure when the position of closure is to the left or right of the first connection node.

12. The apparatus of claim 7, wherein the topology change signal comprises one of a failure occurrence signal, a failure restoration signal, a forced switching signal, a manual switching signal, and a FDB flush message.

13. A method for protection switching in a ring network, comprising:
receiving a FDB flush message by an arbitrary node;
performing a FDB flush operation by the arbitrary node; and
determining whether to transmit or discard the FDB flush message by the arbitrary node.

14. The method of claim 13, wherein said determining whether to transmit or discard the FDB flush message by the arbitrary node comprises transmitting the FDB flush message to a next node by the arbitrary node when the arbitrary node is a normal node.

15. The method of claim 13, wherein said determining whether to transmit or discard the FDB flush message by the node comprises:
confirming, by the connection node, whether the FDB flush message has been transmitted by a peer node corresponding to connection node or not, when the node is a connection node;
discarding, by the connection node, the FDB flush message when the FDB flush message has been transmitted by a peer node corresponding to the connection node; and
transmitting, by the connection node, the FDB flush message to the next node when the FDB flush message has not been transmitted by a peer node corresponding to the connection node.

16. An apparatus for protection switching in a ring network, comprising:
a receiver configured to receive a FDB flush message; and
a controller configured to perform a FDB flush operation and determine whether to transmit or discard the FDB flush message.

17. The apparatus of claim 16, wherein the controller is configured to transmit the FDB flush message to a next node when the FDB flush message is received by a normal node.

18. The apparatus of claim 16, wherein the controller is configured to confirm whether the FDB flush message has been transmitted by a peer node corresponding to the connection node or not, when the FDB flush message is received by a connection node,
the controller is configured to discard the FDB flush message when the FDB flush message has been transmitted by a peer node corresponding to the connection node, and
the controller is configured to transmit the FDB flush message to the next node when the FDB flush message has not been transmitted by a peer node corresponding to the connection node.
